(19) United States
(12) Patent Application Publication
(10) Pub. No.: US 2003/0000374 A1
(43) Pub. Date: Jan. 2, 2003

(54) Hydraulic circuit for working machine

(76) Inventors: Makoto Iga, Tokyo (JP); Yoshiyuki Shimada, Tokyo (JP)

Correspondence Address: Oliff & Berridge, P O Box 19928, Alexandria, VA, 22320, US

(21) Appl. No.: 10/181,154

(22) PCT Filed: Sep. 4, 2001
(86) PCT No.: PCT/JP01/07667

(30) Foreign Application Priority Data
Nov. 20, 2000 (JP) 2000-353168

(51) Int. Cl. F15B 11/08

(52) U.S. Cl. 91/461

(57) ABSTRACT

In an oil hydraulic circuit comprising a pilot operated type control valve for performing control of pressure oil supply to a hydraulic actuator and a pilot valve gear for outputting a pilot pressure to this control valve, in order to improve operationality in a case where a fine operation is performed, the pilot valve gear (8) comprises a first pressure controller (9) for outputting a pilot pressure corresponding to the degree of operation with an operating lever (12) and a second pressure controller (10) for reducing the pilot pressure outputted from this first pressure control means based on a signal from an operating speed changeover switch 16 and outputting the reduced pilot pressure to the control valve 5.

### TECHNICAL FIELD

The present invention relates to a technical field of an hydraulic circuit for a working machine, such as a hydraulic excavator, provided with various hydraulic actuators.

### BACKGROUND ART

In general, various hydraulic actuators are provided in a working machine such as a hydraulic excavator, and working machines exist, which have a structure such that, while control of pressure oil supply to these hydraulic actuators is performed by a pilot operated type control valve, supply of a pilot pressure to the control valve is performed by a pilot valve for outputting a pilot pressure based on an operation with an operating tool. As an example thereof, a hydraulic circuit of a hydraulic cylinder to be provided in a hydraulic excavator is shown in FIG. 6. In the FIG. 6, 1 denotes a hydraulic cylinder, 2 denotes a main hydraulic power source, 3 denotes a pilot hydraulic power source, 4 denotes a reservoir, 5 denotes a control valve, and 17 denotes a pilot valve (herein, in FIG. 6, 6 denotes a control valve for another hydraulic actuator 7 which shares an hydraulic power source of supply with the hydraulic cylinder 1). In this hydraulic circuit, a pilot pressure to be outputted from the pilot valve 17 becomes higher as the degree of operation with a control lever 12 becomes greater, and in addition, as the pilot pressure to be supplied becomes higher, the degree of opening of the control valve 5 becomes greater, the amount of pressure oil to be supplied to the hydraulic cylinder 4 increases, and expanding/contracting speed of the cylinder 1 accelerates. That is, a structure is provided such that the cylinder expanding/contracting speed is controlled in a manner corresponding to the degree of operation with the control lever, and the relationship between the degree of operation with the control lever and cylinder expanding/contracting speed is as shown in FIG. 7, for example.

Meanwhile, in some cases where a minute operation is performed by slowly expanding/contracting the above hydraulic cylinder, such a maximum speed of the hydraulic cylinder as shown in FIG. 7 is not required, but expanding/contracting actions of the cylinder within a low-speed range indicated as the fine operation area are desirable. However, the range of operation with the control lever is narrow within the above fine operation area, therefore, it is necessary to operate the control lever while suppressing the degree of operation to become small, and this makes an operator nervous, requires a great deal of skill, and results in poor workability, in which problems to be solved by the present invention have existed.

### DISCLOSURE OF INVENTION

In light of the circumstances described above, the present invention is created with the aim of solving these problems and provides an oil hydraulic circuit comprising a pilot operated type control valve for performing control of pressure oil supply to a hydraulic actuator and a pilot valve gear for outputting a pilot pressure to this control valve, wherein the pilot valve gear comprises a first pressure control means for outputting a pilot pressure corresponding to the degree of operation with an operating tool and a second pressure control means for reducing the pilot pressure outputted from this first pressure control means based on an external signal and outputting the reduced pilot pressure to the control valve.

Then, by providing such a construction, acting speed of the hydraulic actuator with respect to the degree of operation with the operating tool can be made slow, thus the operationality and workability are improved in, for example, a case where a fine operation is performed.

In this oil hydraulic circuit, the second pressure control means comprises pressure-reducing valves which can switch over the respective states to an inactive state for outputting the pilot pressure from the first pressure control means to the control valve without a reduction, and to an active state for outputting the pilot pressure after a reduction and selector valves which switch over to a first position and to a second position based on an external signal, and furthermore, these selector valves act to bring, at the first position, the respective pressure-reducing valves into an inactive state and, at the second position, into an active state, whereby selection between the case where a pilot pressure to be outputted from the second pressure control means to the control valve is reduced and the case where the same is not reduced can be performed by a switchover of the selector valve based on an external signal.

### BRIEF DESCRIPTION OF THE DRAWINGS

FIG. 1 is a hydraulic circuit diagram of a hydraulic cylinder.

FIG. 2(A) is a diagram showing opening characteristics of a control valve when a hydraulic cylinder is expanded, and FIG. 2(B) is a diagram showing opening characteristics of a control valve when a hydraulic cylinder is contracted.

FIG. 3 is a diagram showing characteristics of a first pressure-reducing valve.

FIG. 4 is a diagram showing characteristics of a second pressure-reducing valve.

FIG. 5 is a diagram showing the relationships between the lever stroke and expanding/contracting speed of a hydraulic cylinder.

FIG. 6 is a hydraulic circuit diagram showing a related art.

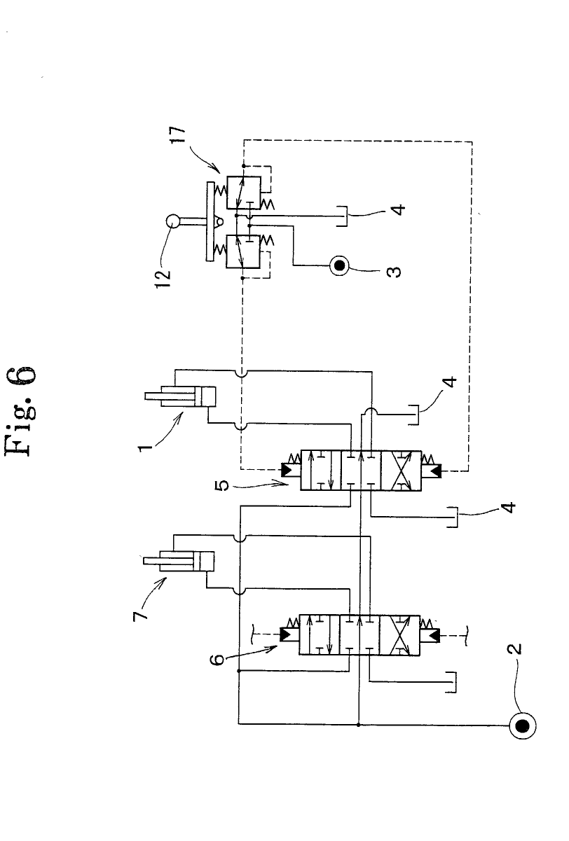

FIG. 7 is a diagram showing the relationship between the lever stroke and expanding/contracting speed of a related art.

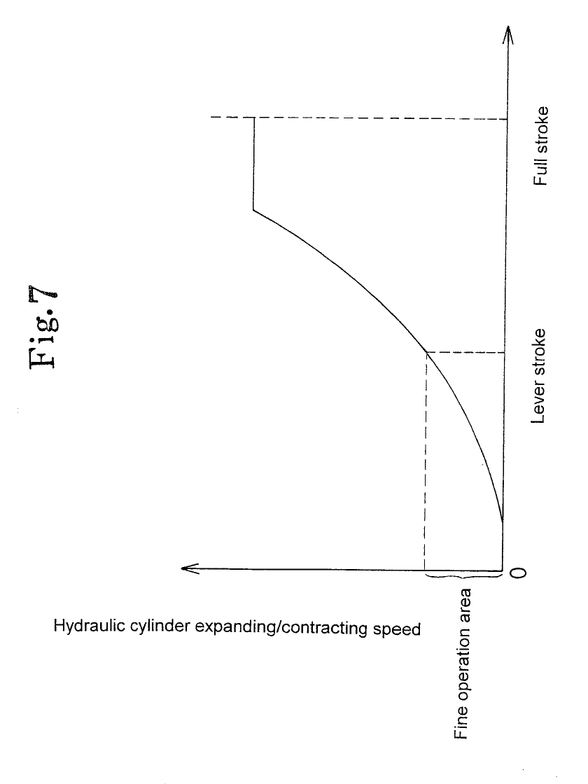

### BEST MODE FOR CARRYING OUT THE INVENTION

Now, an embodiment of the present invention will be described based on the drawings.

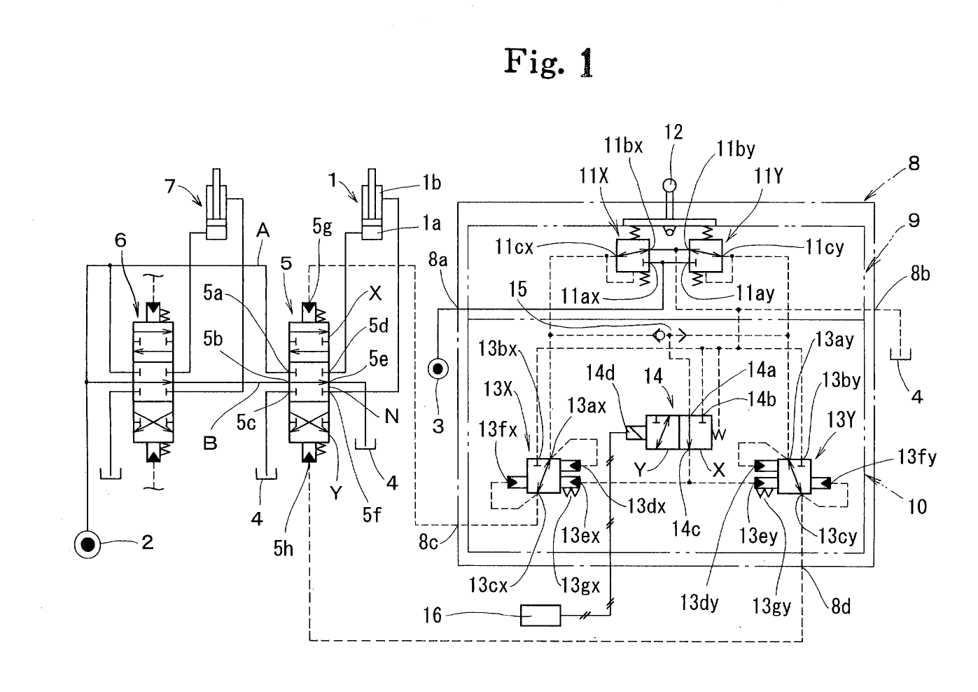

First, in FIG. 1, a hydraulic circuit of a hydraulic cylinder 1 to be provided in a hydraulic excavator is shown. In this hydraulic circuit diagram, 2 denotes a main hydraulic power source, 3 denotes a pilot hydraulic power source, 4 denotes a reservoir, 5 denotes a control valve which performs pressure oil supplying/discharging control of the hydraulic cylinder 1. Herein, in FIG. 1, 6 denotes a control valve for another hydraulic actuator 7 which uses the main hydraulic power source 2 as a hydraulic power source of supply.

The control valve 5 is a pilot operated type three-position selector valve and is provided with first through sixth ports 5a-5f and expanding-side and contracting-side pilot ports 5g, 5h, wherein the first port 5a is connected via a parallel oil path A to the main hydraulic power source 2, the second port 5b is connected via center bypass oil path B to the main hydraulic power source 2, the third port 5c is connected to the reservoir 4, the fourth port 5d is connected to an expanding-side oil chamber 1a of the hydraulic cylinder 1, the fifth port 5e is connected to the reservoir 4, and the sixth port 5f is connected to a contracting-side oil chamber 1b of the hydraulic cylinder 1.

Then, in a condition where no pilot pressure has been inputted to either pilot port 5g or 5h, the control valve 5 is located at a neutral position N where the first, third, fourth, and sixth ports 5a, 5c, 5d, 5f are respectively closed and also a bypassing valve path from the second port 5b to the fifth port 5e (a valve path for allowing pressure oil of the center bypass oil path B to flow to the reservoir 4) is opened.

On the other hand, when a pilot pressure is inputted into the expanding-side pilot port 5g, the control valve 5 switches over to an expanding-side position X where a supplying valve path from the first port 5a to the fourth port 5d (a valve path for supplying pressure oil of the parallel oil path A to the hydraulic cylinder expanding-side oil chamber 1a) and a discharging valve path from the sixth port 5f to the third port 5c (a valve path for discharging oil of the hydraulic cylinder contracting-side oil chamber 1b to the reservoir 4) are opened, whereby the hydraulic cylinder 1 is expanded.

Moreover, when a pilot pressure is inputted into the contracting-side pilot port 5h, the control valve 5 switches over to a contracting-side position Y where a supplying valve path from the first port 5a to the sixth port 5f (a valve path for supplying pressure oil of the parallel oil path A to the hydraulic cylinder contracting-side oil chamber 1b) and a discharging valve path from the fourth port 5d to the third port 5c (a valve path for discharging oil of the hydraulic cylinder expanding-side oil chamber 1a to the reservoir 4) are opened, whereby the hydraulic cylinder 1 is contracted.

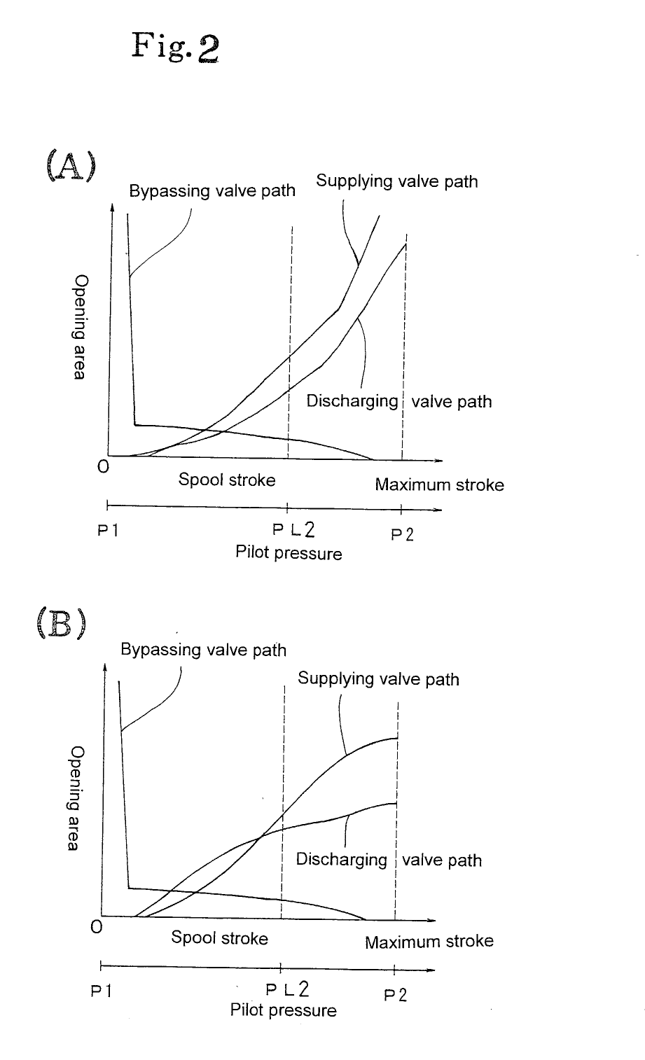

Herein, in terms of the times when the hydraulic cylinder 1 are expanded and contracted, characteristics diagrams showing the relationship between a pilot pressure to be inputted into the expanding-side and contracting-side pilot ports 5g, 5h and a spool stroke of the control valve 5 and an opening area of the bypassing valve path, supplying valve path, and discharging valve path of the control valve 5 are shown in FIG. 2(A) and FIG. 2(B). As shown in these characteristics diagrams, in terms of the control valve 5, as the pilot pressure to be inputted becomes higher, the opening area of the supplying valve path and discharging valve path increases, whereby the amount of pressure oil to be supplied to the hydraulic cylinder 1 is increased, and the cylinder acting speed is increased. Herein, in FIG. 2(A) and FIG. 2(B), P1 represents a minimum control pressure of the control valve 5 (the lowest pilot pressure necessary for the spool to switch over from the neutral position N to the expanding-side position X or the contracting-side position Y) and P2 represents a maximum control pressure of the control valve 5 (the lowest pilot pressure necessary for the spool to shift to a maximum stroke).

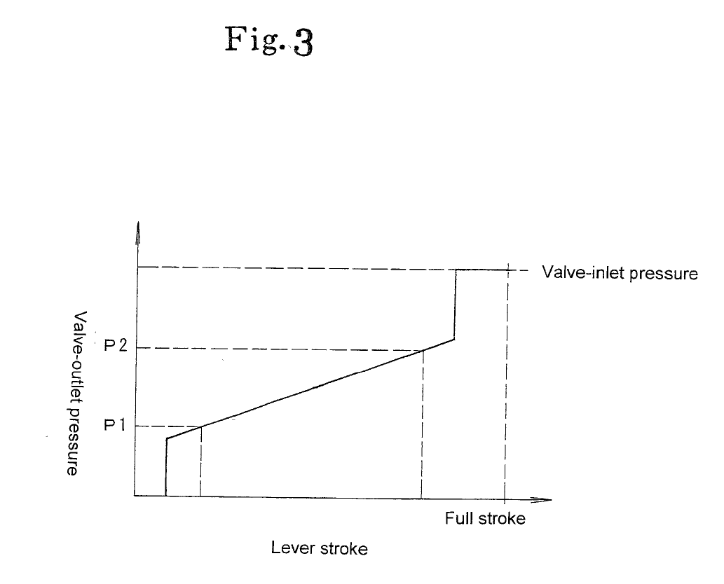

Furthermore, in the hydraulic circuit of FIG. 1, 8 denotes a pilot valve unit. The pilot valve unit 8 is provided with respective ports, that are, a pump port 8a to be connected to the pilot hydraulic power source 3, a tankport 8b to be connected to the reservoir 4, an expanding-side connection port 8c to be connected to the expanding-side pilot port 5g of the control valve 5, and a contracting-side connection port 8d to be connected to the contracting-side pilot port 5h, and also has a first pressure controller 9 and a second pressure controller 10 built-in, which will be described later. The first pressure controller 9 is composed of an expanding-side first pressure-reducing valve 11X and a contracting-side first pressure-reducing valve 11Y, and these first pressure-reducing valves 11X, 11Y are provided with, respectively, input ports 11ax, 11ay to be connected to the pump port 8a, drain ports 11bx, 11by to be connected to the tank port 8b, and output ports 11cx, 11cy to be connected to the second pressure controller 10, which will be described later. Then, in a condition where the control lever 12 for the hydraulic cylinder 1 has not been operated (at a neutral position of the control lever), the contracting-side first pressure-reducing valves 11X, 11Y do not output pilot pressure as the output ports 11cx, 11cy are connected with conductivity to the tank port 8b, however, based on an operation of the control lever 12 to the expanding side and the contracting side, a pilot pressure corresponding to this degree of operation is to be outputted from the output ports 11cx, 11cy. In this case, the relationship between the degree of operation with the control lever 12 (lever stroke) and an output pressure from the output port 11cx, 11cy (valve-outlet pressure) has, in the present embodiment, characteristics as shown in FIG. 3, which are set so that the output pressure (valve-outlet pressure) becomes equal to an inlet pressure (valve-inlet pressure) slightly before a full stroke. Also, in FIG. 3, P1 and P2 represent a minimum control pressure and a maximum control pressure of the control valve 5, which have been described above.

On the other hand, the second pressure controller 10 is composed of an expanding-side second pressure-reducing valve 13X, a contracting-side second pressure-reducing valve 13Y, an electromagnetic selector valve 14, and a shuttle valve 15. The inlet side of this shuttle valve 15 is connected to the output port 11cx of the expanding-side first pressure-reducing valve 11X and the output port 11cy of the contracting-side first pressure-reducing valve 11Y, and the outlet side thereof is connected to a first port 14a of the electromagnetic selector valve 14, which will be described later. Then, the shuttle valve 15 has a structure so that a higher pressure is selected out of pressures inputted from the inlet side and is outputted from the output side, thus in a case where a pilot pressure is outputted from the output port 11cx or 11cy of the expanding-side first pressure-reducing valve 11X or the contracting-side first pressure-reducing valve 11Y, the pilot pressure is to be inputted into the first port 14a through the shuttle valve 15.

In addition, the electromagnetic selector valve 14 is a two-position selector valve provided with first through third ports 14a-14c, wherein the first port 14a is connected to the outlet side of the shuttle valve 15, the second port 14b is connected to the tank port 8b, and the third port 14c is connected to second pistons 13ex, 13ey of the expanding-side second pressure-reducing valve 13X and the contracting-side second pressure-reducing valve 13Y, respectively, which will be described later.

Then, in a state where a solenoid 14d is unexcited, the electromagnetic selector valve 14 is located at a first position X where a valve path from the first port 14a to the third port 14c is opened and the second port 14b is closed. Then, in the condition where the electromagnetic selector valve 14 is located at the first position X, an outlet-side pressure of the shuttle valve 15, that is, a pilot pressure outputted from the output port 11cx or 11cy of the expanding-side first pressure-reducing valve 11X or the contracting-side first pressure-reducing valve 11Y is applied to the second pistons 13ex and 13ey of the expanding-side and contracting-side second pressure-reducing valves 13X and 13Y through the electromagnetic selector valve 14 located at the first position X.

On the other hand, in a state where the solenoid 14d is excited, the electromagnetic selector valve 14 closes the first port 14a and also switches over to a second position Y where the second port 14b and the third port 14c are communicated with each other. Then, in the condition where the electromagnetic selector valve 14 is located at the second position Y, an application line to the second pistons 13ex, 13ey of the expanding-side and contracting-side second pressure-reducing valves 13X, 13Y is connected with conductivity to the tank port 8b via the electromagnetic selector valve 14 located at the second position Y.

Herein, the solenoid 14d of the electromagnetic selector valve 14 has an electrical interconnection with an operating speed changeover switch l6 provided on an operator's seat portion or the like of the hydraulic excavator 1, and is in an unexcited state when the operating speed changeover switch 16 is OFF, but is excited based on turning ON of the operating speed changeover switch 16.

In addition, the expanding-side and contracting-side second pressure-reducing valves l3X, 13Y are provided with input ports 13ax, 13ay, drain ports 13bx, 13by, output ports 13cx, 13cy, first pistons 13dx, 13dy, second pistons 13ex, 13ey, third pistons 13fx, 13fy, and springs 13gx, 13gy, and terms of the expanding-side second pressure-reducing valve 13X, the input port 13ax is connected to the output port 11cx of the expanding-side first pressure reducing valve 11X, the drain port 13bx is connected to the tank port 8b, and the output port 13cx is connected to the expanding-side connection port 8c. In addition, in terms of the contracting-side second pressure-reducing valve 13Y, the input port 13ay is connected to the output port 11cy of the contracting-side first pressure-reducing valve 11Y, the drain port 13by is connected to the tank port 8b, and the output port 13cy is connected to the contracting-side connection port 8d. Furthermore, output pressures from the output ports 11cx, 11cy of the expanding-side and contracting-side first pressure-reducing valves 11X, 11Y are, respectively, applied to the first pistons 13dx, 13dy of the expanding-side and contracting-side second pressure-reducing valves 13X, 13Y, an output pressure from the output port 11cx or 11cy of the expanding-side first pressure-reducing valve 11X or the contracting-side first pressure-reducing valve 11Y is applied, as described above, to the second piston 13ex or 13ey via the electromagnetic selector valve 14 located at the first position X, and output pressures from the output ports 13cx, 13cy are applied to the third pistons 13fx, 13fy.

Then, the first and second pistons 13dx, 13dy, 13ex, 13ey and the springs 13gx, 13gy press the valve bodies of the second pressure-reducing valves 13X, 13Y to the side for an inactive state for outputting a pressure, which has been inputted into the input ports 13ax, 13ay, without it reduction from the output ports 13cx, 13cy, and also the third pistons 13fx, 13fy press the valve bodies of the second pressure-reducing valves 13X, 13Y to the side for an active state for outputting a pressure, which has been inputted into the input ports 13ax, 13ay, from the output ports 13cx, 13cy by being reduced.

Herein, in a condition where the control lever 12 has been operated to the expanding side or the contracting side and a pilot pressure has been outputted from the output port 11cx or 11cy of the expanding-side or contracting-side first pressure-reducing valve 11X or 11Y, the relationship between force F1 for depressing the second pressure-reducing valves 13X and 13Y to the inactive state side and force F2 for pressing the second pressure-reducing valve 13X or 13Y to the active side is set as follows.

Namely, a relationship is set so that in a condition where the electromagnetic selector valve 14 is located at the first position X and an output pressure from the output port 11cx or 11cy of the expanding side first pressure-reducing valve 11X or the contracting-side first pressure-reducing valve 11Y has been applied to the second piston 13ex or 13ey, the force F1 for pressing the second pressure-reducing valve 13X or 13Y to the inactive state side becomes greater than the force F2 for pressing the same to the active state side (F1>F2),meanwhile in a condition where the electromagnetic selector valve 14 is located at the second position Y and the application line to the second piston 13ex or 13ey is connected with conductivity to the tank port 8b, the force F2 for pressing the second pressure-reducing valve 13X or 13Y to the active state side becomes greater than the force F1 for pressing the same to the inactive state side (F2>F1).

Then, in the case where the force F1 for pressing the second pressure-reducing valve 13X or 13Y to the inactive state side is greater than the force F2 for pressing the same to the active state side (Fl>F2), the second pressure reducing valve 13X or 13Y is retained in an inactive state for outputting a pressure, which has been inputted into the input port 13ax or 13ay, from the output port 13cx or 13cy without a reduction. Thus, a pilot pressure outputted from the expanding-side or contracting-side first pressure-reducing valve 11X or 11Y in a manner corresponding to the degree of operation with the control lever 12 is, without a reduction, outputted from the expanding-side or contracting-side connection port 8c or 8d via the expanding-side or contracting-side second pressure-reducing valve 13X or 13Y in an inactive state, and is supplied to the expanding-side or contracting-side pilot port 5g or 5h of the control valve 5.

On the other hand, in the case where the force F2 for pressing the second pressure-reducing valve 13X or 13Y to the active state side is greater than the force F1 for pressing the same to the inactive state side (F2>F1), the second pressure-reducing valve 13X or 13Y is brought into an active state for outputting a pressure, which has been inputted into the input port 13ax or 13ay, from the output port 13cx or 13cy by being reduced. Thus, a pilot pressure outputted from the expanding-side or contracting-side first pressure-reducing valve 11X or 11Y in a manner corresponding to the degree of operation with the control lever 12 is, after a reduction by the second pressure-reducing valve 13X or 13Y in an active state, outputted from the expanding-side or contracting-side connection port 8c or 8d, and is supplied to the expanding-side or contracting-side pilot port 5g or 5h of the control valve 5.

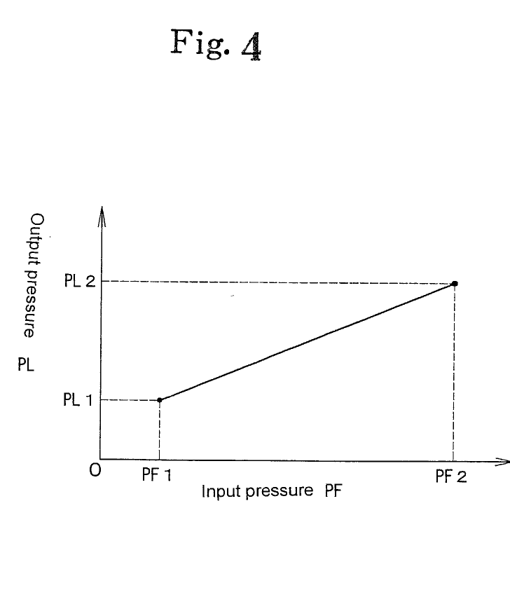

Herein, a pressure reducing action of the active second pressure-reducing valve 13X or 13Y in the above active state is shown in a characteristics diagram of FIG. 4. In this FIG. 4, a minimum value PL1 of an output pressure PL from the output port 13cx or 13cy is equal to a minimum value PF1 of an input pressure PF inputted into the input port 13ax or 13ay (PL1=PF1), and in addition, a maximum value PL2 of the output pressure PL becomes smaller than a maximum value PF2 of the input pressure PF (PL2<PF2). Furthermore, the maximum value PL2 of the output pressure PL is set so as to become smaller than the maximum control pressure P2 of the control valve 5 (PL2<P2) (refer to FIG. 2(A) and FIG. 2(B)).

In addition, FIG. 4 shows such control that the output pressure PL with respect to the input pressure PF is reduced in a linear relationship (a proportionality relation), however, it is also possible to employ a non-linear relationship.

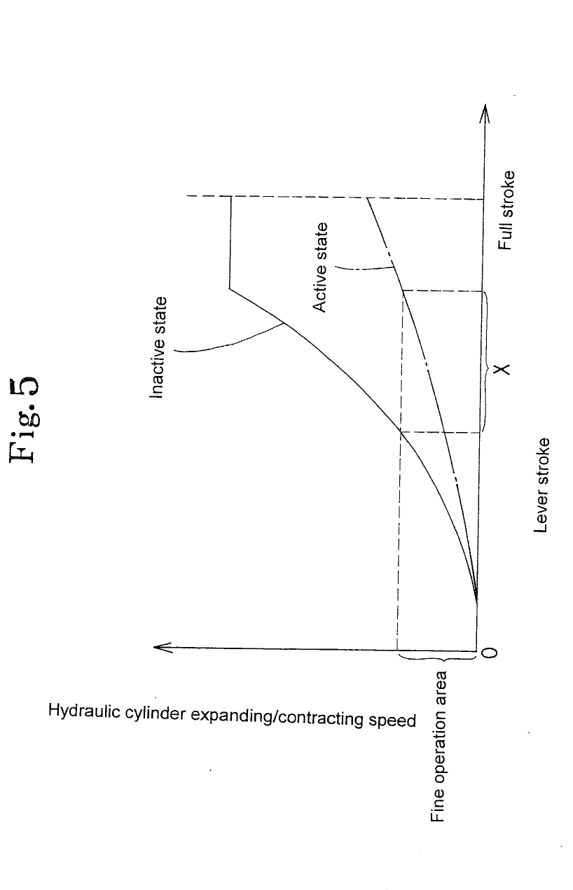

Furthermore, the relationships between the lever stroke of the control lever 12 and expanding/contracting speed of the hydraulic cylinder 1 when the second pressure-reducing valve 13X or 13Y is in an inactive state and in an active state are shown in FIG. 5. As shown in the FIG. 5, in the active state of the second pressure-reducing valve 13X or 13Y, the expanding/contracting speed of the hydraulic cylinder 1 declines throughout the whole lever stroke area. Moreover, in the active state of the second pressure-reducing valve 13X or 13Y, the lever stroke range in a low-speed area of the hydraulic cylinder 1, which is shown in FIG. 5 as a fine operation area, becomes broader by X than that of the inactive state.

In the present embodiment structured as has been described above, the pilot valve unit 8 for outputting a pilot pressure to the control valve 5 which performs pressure oil supplying/discharging control of the hydraulic cylinder 1 comprises the first pressure controller 9 for outputting a pilot pressure corresponding to the degree of operation with the control lever 12 and the second pressure controller 9 for reducing the pilot pressure outputted from the first pressure controller 9 based on turning ON of the operating speed changeover switch 16 and outputting the reduced pilot pressure to the control valve 5.

As a result, in a case where a minute operation is performed by slowly expanding/contracting the hydraulic cylinder 1 without requiring its maximum speed, by turning ON the operating speed changeover switch 16, a pilot pressure to be outputted from the pilot valve unit 8 to the control valve 5 declines, and the expanding/contracting speed of the hydraulic cylinder 1 with respect to the degree of operation with the control lever 12 becomes slow throughout the whole lever stroke area. Thus, in the case where a fine operation of the hydraulic cylinder is performed, a lever control which conventionally requires a great deal of skill where operation is minutely performed while suppressing the degree of operation to become small becomes unnecessary, whereby operationality and workability are improved.

Moreover, herein, the pilot valve unit 8 has a structure where the first pressure controller 9 for outputting a pilot pressure corresponding to the degree of operation with the control lever 12 and the second pressure control means 10 for reducing the pilot pressure outputted from this first pressure controller 9 are integrally built in, therefore, installation into a working machine such as a hydraulic excavator is easily carried out, and also an advantage exists such that in a case where this pilot valve unit 8 is attached in place of an existing pilot valve, replacement is easily carried out.

As a matter of course, the present invention is not limited to the above embodiment, and means for outputting an external signal to cause the second pressure control means to perform a pressure reducing action is not limited to the operating speed changeover switch 16 and any means may be employed as long as it can output an external signal to the second pressure control means when necessity arises.

In addition, as a structure of the second pressure control means, a structure may also be employed such that pressure-reducing valves for outputting a pilot pressure to be outputted from the first pressure control means to a control valve after a reduction and selector valves which switch over to a first position and a second position based on an external signal are provided, and furthermore, these selector valves act so as to supply, at the first position, a pilot pressure from the first pressure control means to the control valve without passing through the pressure-reducing means, and to supply, at the second position, the same to the control valve through the pressure-reducing valve.

Furthermore, in the above embodiment, the pilot valve unit wherein the present invention has been carried out is provided in the hydraulic circuit of the hydraulic cylinder of a hydraulic excavator, however, it may also be provided in an hydraulic circuit of a hydraulic motor such as a travelling motor and a motor for rotation and another hydraulic actuator such as a hydraulic actuator for attachment. In addition, the present invention may be carried out not only in a hydraulic excavator but also in various working machines provided with hydraulic actuators.

Industrial Applicability

A pilot valve unit of the present invention comprises a first pressure control means for outputting a pilot pressure corresponding to the degree of operation with an operating tool and a second pressure control means for reducing the pilot pressure outputted from this first pressure control means based on an external signal and outputting the reduced pilot pressure to the control valve. As a result, the acting speed of a hydraulic actuator with respect to the degree of operation with the operating tool can be made slow throughout the whole operating area of the operating tool when necessity arises, whereby, for example, in the case where a fine operation is performed, operationality and workability are improved.

In addition, the first pressure control means and the second pressure control means are integrally built in this pilot valve gear, therefore, installation into a working machine is easily carried out, and also an advantage exists such that in a case where this pilot valve gear is attached in place of an existing pilot valve, replacement is easily carried out.

What is claimed is:

1. A hydraulic circuit for a working machine comprising:
a pilot operated type control valve for performing control of pressure oil supply to a hydraulic actuator and
a pilot valve unit for outputting a pilot pressure to this control valve, wherein
said pilot valve unit comprises a first pressure control means for outputting a pilot pressure corresponding to the degree of operation with an operating tool and
a second pressure control means for reducing the pilot pressure outputted from this first pressure control means based on an external signal and outputting the reduced pilot pressure to the control valve.

2. A hydraulic circuit for a working machine as set forth in claim 1, wherein
the second pressure control means comprises pressure-reducing valves which can switch between an inactive state for outputting the pilot pressure from the first pressure control means to the control valve without a reduction and an active state for outputting the pilot pressure after a reduction and
selector valves which switch between a first position and a second position based on an external signal, and furthermore, these selector valves act to bring, at the first position, the respective pressure-reducing valves into an inactive state and, at the second position, into an active state.
